(19) United States
(12) Patent Application Publication
(10) Pub. No.: US 2020/0197736 A1
(43) Pub. Date: Jun. 25, 2020

(54) BIOLOGICAL COMPOSITION FOR DEGRADING PLANT PESTICIDE RESIDUES AND THE APPLICATION THEREOF

(71) Applicant: SICHUAN HUI TAI AGRICULTURAL TECHNOLOGY CO. LTD., Chengdu (CN)

(72) Inventors: Lezhang CHEN, Chengdu (CN); Junbo YANG, Chengdu (CN)

(21) Appl. No.: 16/710,545

(22) Filed: Dec. 11, 2019

(30) Foreign Application Priority Data
Dec. 21, 2018 (CN) 201811573303.7

(51) Int. Cl. A62D 3/02; B09C 1/10; C12R 1/225; C12R 1/125; C12R 1/645

(52) U.S. Cl. CPC A62D 3/02; B09C 1/105; A62D 2101/04; C12R 1/125; C12R 1/645; C12R 1/225

(57) ABSTRACT

A method for preparing a biological composition for degrading plant pesticide residues includes: (1) preparing a mixture of a dried coconut shell powder having a water content of less than 3 wt % and a particle diameter of not more than 2 mm and a dried licorice powder having a water content of less than 1 wt % and a particle diameter of not more than 2 mm; (2) hydrolyzing the mixture in a cellulase buffer at pH 4.5 to 5.5 for at least 36 hours, and filtering the mixture to obtain an enzymatic hydrolysate; and (3) adding the enzymatic hydrolysate to a bacteria mixture of yeast and lactic acid bacteria and fermenting at 30° C. to 35° C. for 7-10 days, and centrifuging and lyophilizing to obtain the biological composition.

The present invention claims priority to Chinese Patent Application No. 201811573303.7, filed on Dec. 21, 2018, which is incorporated by reference for all purposes as if fully set forth herein.

### FIELD OF THE INVENTION

The present invention relates to a biological composition for degrading plant pesticide residues and the application thereof.

### BACKGROUND OF THE INVENTION

With the continuous change of the ecological environment, in crop planting, more and more pesticides are used to control pests and diseases, which leads to more and more pesticide residues on crops. The term “pesticide residue” refers to a trace amount of agrochemicals, toxic metabolites, degradants and impurities that have not been decomposed and remain in organisms, harvests, soil, water, and atmosphere for a period of time after use. The pesticides currently used, except for a small number of biodegradable pesticides, are mostly chemical pesticides, and these chemical pesticides are mainly organic phosphorus (e.g., methamidophos) and organic chlorine (e.g., DDT). Pesticide residues and the degradation products there are toxic and harmful. If they enter the human body, they will cause serious harm to human health. Pesticide residues are common in vegetables and fruits.

To remove the problem of pesticide residues, there are two treatment methods. The first method is physical method, i.e., rinsing with water and detergent to remove pesticide residues from the surface of vegetables and fruits, for example, Chinese patent application publications nos. CN 107723114 A and CN 108587797 A. Although this method can remove the pesticide residue on the surface of the crop to a certain extent, the pesticide residue is discharged into the water for secondary pollution. The second method is biodegradation, i.e., degrading organic phosphorus, organic chlorine and other pesticides into non-toxic and harmless small molecules dissolved in water. For example, Chinese patent application publication no. CN 108031711 A discloses a microbial fermented product that degrades the pesticide residues in soil. Although the fermented product can degrade the pesticide residue in the soil, the degradation effect on the pesticide residue on the surface of the crop is poor, specifically poor degradation effect on the organochlorine pesticides.

### SUMMARY OF THE INVENTION

In one embodiment, the present invention provides a method for preparing a biological composition for degrading plant pesticide residues. The method includes: (1) preparing a mixture of a dried coconut shell powder having a water content of less than 3 wt % and a particle diameter of not more than 5 mm and a dried licorice powder having a water content of less than 1 wt % and a particle diameter of not more than 2 mm; (2) hydrolyzing the mixture in a cellulase buffer at pH 4.5 to 5.5 for at least 36 hours, and filtering the mixture to obtain an enzymatic hydrolysate; and (3) adding the enzymatic hydrolysate to a bacteria mixture of yeast and lactic acid bacteria and fermenting at 30° C. to 35° C. for 7-10 days, and centrifuging and lyophilizing to obtain the biological composition.

In another embodiment, the cellulase buffer is a citric acid-sodium citrate buffer containing 10-15 wt % of cellulase.

In another embodiment, in step (2), a weight ratio of the mixture and the cellulase buffer is 2-3 to 10.

In another embodiment, the yeast is prepared by fermenting grapes.

In another embodiment, the bacteria mixture further comprises Bacillus subtilis.

In another embodiment, the method further includes applying the biological composition onto crops one week before harvest.

In another embodiment, the method further includes mixing the biological composition with water in a weight ratio of 5-10 to 95-90.

In one embodiment, the present application provides a biological composition for degrading plant pesticide residues prepared by the method of the present invention.

The present invention has the following advantages. The biological composition of the present invention has excellent degradation effect on the pesticide residues of the crop, especially organophosphorus pesticides (98.1% degradation) and organochlorine pesticides (98.6% degradation). The composition is also effective on the pesticide residues in the soil. The preparation method of the composition simple, the cost is low, and the economic and environmental benefits are significant.

It is to be understood that both the foregoing general description and the following detailed description are exemplary and explanatory and are intended to provide further explanation of the invention as claimed.

### DETAILED DESCRIPTION OF THE ILLUSTRATED EMBODIMENTS

Reference will now be made in detail to embodiments of the present invention.

### Example 1

A biological preparation for degrading plant pesticide residues, which is prepared by the following method:

(1) Raw materials: dried coconut shell having a water content of less than 3 wt % was pulverized to a particle diameter of not more than 5 mm, and dried licorice having a water content of less than 1 wt % was pulverized to a particle diameter of not more than 2 mm. 1,000 grams of the dried coconut shell powder and 1,600 grams of the dried licorice powder were mixed for use.

(2) Enzymatic hydrolysis: the mixture obtained in the step (1) was placed in a cellulase buffer, soaked for 40 hours, and then filtered, and the precipitate after filtration was dried to obtain an enzymatic hydrolysate.

The cellulase buffer was a citric acid-sodium citrate buffer, and contained 15 wt % of the cellulase. The mass ratio of the mixture to the cellulase buffer was 3:10. The cellulase activity of the cellulase buffer was 160 KU/g. The enzymatic hydrolysis was treated with microwave at a radiation of 350-400 w, for 15 minutes every 3 hours.

(3) Fermentation: the enzymatic hydrolysate obtained in the step (2) was added to a mixed bacteria solution of yeast, lactic acid bacteria, and Bacillus subtilis, uniformly mixed, and fermented at a temperature of 30° C.-35° C. for 10 days, and then centrifugated to collecting a solid. The solid was lyophilized to obtain the biological composition.

The yeast was prepared by fermenting grapes by using raisins as raw materials. Raisins were placed in a closed container, and water was added in an amount of 5 times the mass of the raisins. The container was sealed and fermented at 25° C.−35° C. for at least 5 days. The container was opened to ventilate every day, and shaken at least three times a day for at least 5 minutes each time.

The lactic acid bacteria is a commercially available plant-derived lactic acid bacteria (Wuhan Yuan Cheng Gong Chuang Technology Co., Ltd.).

Bacillus subtilis was purchased from the Chinese Medical Bacterial Collection Management Center CMCC 63501.

The weight ratio of yeast, lactic acid bacteria and Bacillus subtilis is 1.5:1:1.5.

The lyophilization was carried out by a method generally used in the art. Sodium glutamate is used as a lyoprotectant, pre-frozen at −30° C., and then freeze-dried in a freeze dryer.

The biological composition prepared in this example was “Product A.”

### Example 2

A biological preparation for degrading plant pesticide residues, which is prepared by the following method:

(1) Raw materials: dried coconut shell having a water content of less than 3 wt % was pulverized to a particle diameter of not more than 5 mm, and dried licorice having a water content of less than 1 wt % was pulverized to a particle diameter of not more than 2 mm. 1,000 grams of the dried coconut shell powder and 1,600 grams of the dried licorice powder were mixed for use.

(2) Enzymatic hydrolysis: the mixture obtained in the step (1) was placed in a cellulase buffer, soaked for 40 hours, and then filtered, and the precipitate after filtration was dried to obtain an enzymatic hydrolysate.

The cellulase buffer was a citric acid-sodium citrate buffer, and contained 15 wt % of the cellulase. The mass ratio of the mixture to the cellulase buffer was 3:10. The cellulase activity of the cellulase buffer was 160 KU/g. The enzymatic hydrolysis was treated with microwave at a radiation of 350-400 w, for 15 minutes every 3 hours.

(3) Fermentation: the enzymatic hydrolysate obtained in the step (2) was added to a mixed bacteria solution of yeast and lactic acid bacteria, uniformly mixed, and fermented at a temperature of 30° C.-35° C. for 10 days, and then centrifugated to collecting a solid. The solid was lyophilized to obtain the biological composition.

The yeast was prepared by fermenting grapes by using raisins as raw materials. Raisins were placed in a closed container, and water was added in an amount of 5 times the mass of the raisins. The container was sealed and fermented at 25° C.-35° C. for at least 5 days. The container was opened to ventilate every day, and shaken at least three times a day for at least 5 minutes each time.

The lactic acid bacteria is a commercially available plant-derived lactic acid bacteria (Wuhan Yuan Cheng Gong Chuang Technology Co., Ltd.).

The weight ratio of yeast and lactic acid bacteria is 1.5:1.

The lyophilization was carried out by a method generally used in the art. Sodium glutamate is used as a lyoprotectant, pre-frozen at −30° C., and then freeze-dried in a freeze dryer.

The biological composition prepared in this example was “Product B.”

### Example 3

A biological preparation for degrading plant pesticide residues, which is prepared by the following method:

(1) Raw materials: dried coconut shell having a water content of less than 3 wt % was pulverized to a particle diameter of not more than 5 mm, and dried licorice having a water content of less than 1 wt % was pulverized to a particle diameter of not more than 2 mm. 1,000 grams of dried coconut shell powder and 1,600 grams of dried licorice powder were mixed for use.

(2) Enzymatic hydrolysis: the mixture obtained in the step (1) was placed in a cellulase buffer, soaked for 40 hours, and then filtered, and the precipitate after filtration was dried to obtain an enzymatic hydrolysate.

The cellulase buffer was a citric acid-sodium citrate buffer, and contained 15 wt % of the cellulase. The mass ratio of the mixture to the cellulase buffer was 3:10. The cellulase activity of the cellulase buffer was 160 KU/g. The enzymatic hydrolysis was treated with microwave at a radiation of 350-400 w, for 15 minutes every 3 hours.

(3) Fermentation: the enzymatic hydrolysate obtained in the step (2) was added to a mixed bacteria solution of yeast, lactic acid bacteria, and Bacillus subtilis, uniformly mixed, and fermented at a temperature of 30° C.-35° C. for 10 days, and then centrifugated to collecting a solid. The solid was lyophilized to obtain the biological composition.

The yeast was regular commercially available common yeast.

The lactic acid bacteria was a commercially available plant-derived lactic acid bacteria (Wuhan Yuan Cheng Gong Chuang Technology Co., Ltd.).

Bacillus subtilis was purchased from the Chinese Medical Bacterial Collection Management Center CMCC 63501.

The weight ratio of yeast, lactic acid bacteria and Bacillus subtilis is 1.5:1:1.5.

The lyophilization was carried out by a method generally used in the art. Sodium glutamate is used as a lyoprotectant, pre-frozen at −30° C., and then freeze-dried in a freeze dryer.

The biological composition prepared in this example was “Product C.”

Experimental Results:

1. Degrading Organochlorine Pesticides

This experiment uses the degradation of chlorothalonil as an example.

Chlorothalonil, tetrachloroisophthalonitrile, can prevent melon downy mildew, powdery mildew, anthracnose, blight; tomato early blight, late blight, cucumber gray mold, leaf mold. It is generally applied to cucumber, tomato, etc. GB 25193-2010 regulates that the limit of chlorothalonil on tomato and cucumber is 5 mg/kg.

1.1 Experimental Subjects

Experimental subjects are cucumber and tomato. Chlorothalonil was sprayed according to normal application requirements. Five test sites were used, and each test site was 0.1 mu.

1.2 Experimental Agents

“Product A,” “Product B,” and “Product C” prepared in Example 1-3 of the present invention were used as experimental agents. Product A in Example 1 of CN 108031711 A was used as control example. Experimental agents and control example all contain 15 wt % of the biological compositions. Blank example contains water only. Experimental agents, control example, and blank example were sprayed on the surface of cucumber and tomato one week before picking cucumber and tomato to fully wet the surface, and sprayed to the soil as well to fully wet the soil.

The content of chlorothalonil in harvested cucumber and tomato was measured; and the content of chlorothalonil in the soil before spraying and at the time of picking was also detected;

The method for measuring the content of chlorothalonil in cucumber tomato was carried out according to the method specified in GB/T 5009.105-2003. The test results are shown in Table 1.

TABLE 1
Residual Content of Chlorothalonil
in Cucumber and Tomato (mg/kg)

| | Cucumber | Tomato |
|---|---|---|
| Product A | 0.09 | 0.08 |
| Product B | 0.15 | 0.16 |
| Product C | 0.18 | 0.21 |
| Control Example | 3.15 | 2.93 |
| Blank Example | 9.6 | 8.5 |

The method for measuring the content of chlorothalonil in soil was carried out according to the method specified in DB22/T 2084-2014. The test results are shown in Table 2.

TABLE 2
Residual Content of Chlorothalonil in Soil (mg/kg)

| | Cucumber | | Tomato | |
|---|---|---|---|---|
| | Before | | Before | |
| | spraying | Harvest | spraying | Harvest |
| Product A | 335 | 53 | 313 | 50 |
| Product B | 335 | 69 | 313 | 65 |
| Product C | 335 | 71 | 313 | 69 |
| Control Example | 335 | 136 | 313 | 131 |
| Blank Example | 335 | 331 | 313 | 309 |

As can be seen from Tables 1 and 2, the biological agent of the present invention is a principle of degradation of agricultural residues on the surface of agricultural products, and is not a physical cleaning because the content of chlorothalonil in the soil does not increase.

2. Experiment on the Degradation of Organophosphorus Pesticides

This experiment uses the degradation of triazophos as an example.

Triazophos is mainly used for controlling lepidopteran pests, mites, fly larvae and underground pests on fruit trees, cotton and grain crops. The present invention uses rice sprayed triazophos as an example.

2.1 Experimental Subjects

Experimental subjects are rice. Triazophos was sprayed according to normal application requirements. Five test sites were used, and each test site was 0.3 mu.

2.2 Experimental Agents

“Product A,” “Product B,” and “Product C” prepared in Example 1-3 of the present invention were used as experimental agents. Product A in Example 1 of CN 108031711 A was used as control example. Experimental agents and control example all contain 15 wt % of the biological compositions. Blank example contains water only. Experimental agents, control example, and blank example were sprayed on the surface of rice one week before harvest to fully wet the surface.

The content of triazophos in the harvested rice was then measured.

The method for detecting the content of triazophos was carried out according to the method specified in GB/T20769-2008. The test results are shown in Table 3.

TABLE 3
Residues of Rriazophos in Rice (mg/kg)

| | |
|---|---|
| Product A | 0.36 |
| Product B | 0.51 |
| Product C | 0.61 |
| Control Example | 3.99 |
| Blank Example | 23.1 |

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for preparing a biological composition for degrading plant pesticide residues comprising:
(1) preparing a mixture of a dried coconut shell powder having a water content of less than 3 wt % and a particle diameter of not more than 5 mm and a dried licorice powder having a water content of less than 1 wt % and a particle diameter of not more than 2 mm;
(2) hydrolyzing the mixture in a cellulase buffer at pH 4.5 to 5.5 for at least 36 hours, and filtering the mixture to obtain an enzymatic hydrolysate; and
(3) adding the enzymatic hydrolysate to a bacteria mixture of yeast and lactic acid bacteria and fermenting at 30° C. to 35° C. for 7-10 days, and centrifuging and lyophilizing to obtain the biological composition.

2. The method of claim 1, wherein the cellulase buffer is a citric acid-sodium citrate buffer containing 10-15 wt % of cellulase.

3. The method of claim 1, wherein, in step (2), a weight ratio of the mixture and the cellulase buffer is 2-3 to 10.

4. The method of claim 1, wherein the yeast is prepared by fermenting grapes.

5. The method of claim 1, wherein the bacteria mixture further comprises Bacillus subtilis.

6. The method of claim 1, further comprising:
applying the biological composition onto crops one week before harvest.

7. The method of claim 1, further comprising:
mixing the biological composition with water in a weight ratio of 5-10 to 95-90.

8. A biological composition for degrading plant pesticide residues prepared by the method of claim 1.
